(19) United States
(12) Patent Application Publication
(10) Pub. No.: US 2018/0167366 A1
(43) Pub. Date: Jun. 14, 2018

(54) CRYPTOGRAPHIC MODE PROGRAMMABILITY

(71) Applicant: QUALCOMM Incorporated, San Diego, CA (US)

(72) Inventors: Rosario CAMMAROTA, San Diego, CA (US); Matthew McGregor, El Segundo, CA (US)

(21) Appl. No.: 15/376,481

(22) Filed: Dec. 12, 2016

(51) Int. Cl. H04L 29/06; G06F 21/72; H04L 9/14

(52) U.S. Cl. CPC H04L 63/0428; H04L 2209/12; H04L 9/14; G06F 21/72

(57) ABSTRACT

A cryptographic device includes: a data input; a data output; a cipher circuit configured to perform a cipher algorithm on cipher-algorithm input data to produce cipher-algorithm output data; and a network coupled to the data input, the data output, and the cipher circuit, the network comprising a plurality of switches and a plurality of logical signal combiners that are configured to provide the cipher-algorithm input data to the cipher circuit and to provide device output data to the data output using the cipher-algorithm output data and that, in combination with the cipher circuit, are configured to implement a plurality of different cryptographic algorithms that each include the cipher algorithm that the cipher circuit is configured to perform.

### BACKGROUND

There are many different types of electronic communication today. Standards have been developed for different types of communication, including different types of cryptography (encryption and decryption) for data being communicated. Often a single communication device is capable of several different types of communication. For example, a smart phone may employ one type of cryptography for voice communications and another type of cryptography for Internet data traffic. To accommodate different types of cryptography, physically separate, dedicated circuits for each type of cryptography are provided in a single device, and the appropriate circuit is selected based on the type of communication involved.

### SUMMARY

An example of cryptographic device includes: a data input; a data output; a cipher circuit configured to perform a cipher algorithm on cipher-algorithm input data to produce cipher-algorithm output data; and a network coupled to the data input, the data output, and the cipher circuit, the network comprising a plurality of switches and a plurality of logical signal combiners that are configured to provide the cipher-algorithm input data to the cipher circuit and to provide device output data to the data output using the cipher-algorithm output data and that, in combination with the cipher circuit, are configured to implement a plurality of different cryptographic algorithms that each include the cipher algorithm that the cipher circuit is configured to perform.

Implementations of such a device may include one or more of the following features. The cipher circuit is a single instance of the cipher circuit. The network includes a controller configured to be programmed to actuate the plurality of switches differently to implement the plurality of different cryptographic algorithms. The controller is configured to be programmed to actuate the plurality of switches differently to cause different logical combinations of signals to provide different cipher-algorithm input data from the data input to the cipher circuit and/or to cause different logical combinations of the cipher-algorithm output data to provide the device output data to the data output to implement the plurality of different cryptographic algorithms. The controller is configured to be programmed to actuate the plurality of switches differently to effect values of respective variables in equations representing the plurality of different cryptographic algorithms to implement the plurality of different cryptographic algorithms. The controller is configured to be programmed to actuate the plurality of switches differently to effect values of respective variables in an initial-state encryption equation, a steady-state encryption equation, an initial-state decryption equation, and a steady-state decryption equation to implement the plurality of different cryptographic algorithms. The controller implements a state machine. The controller comprises a memory and a processor communicatively coupled to the memory, the memory comprising processor-readable instructions configured to cause the processor to actuate the plurality of switches selectively.

Also or alternatively, implementations of such a device may include one or more of the following features. The device further includes an authentication circuit coupled to the network and configured to determine an authentication tag, the network being configured to provide a constant logical zero signal to the authentication circuit during a time when the cryptographic device is active but the authentication circuit is not determining the authentication tag. The device further includes an authentication circuit coupled to the network and configured to determine an authentication tag in combination with the network, the authentication circuit being separate from the cipher circuit, where the network is configured such that at least a same one of the plurality of switches and/or at least a same one of the plurality of logical signal combiners is used to perform at least one of the plurality of different cryptographic algorithms and to determine the authentication tag. The network and the cipher circuit are configured to implement the plurality of different cryptographic algorithms without an unregulated loop.

Another example of a cryptographic device includes: a data input configured to receive cryptographic algorithm input data; a data output; and means, coupled to the data input and the data output, for implementing a plurality of different cryptographic algorithms, the means for implementing comprising: cipher means for performing a cipher algorithm on cipher-algorithm input data to produce cipher-algorithm output data; and network means, coupled to the cipher means, for producing, based upon the cryptographic algorithm being implemented, cipher-algorithm input data from the cryptographic algorithm input data, for providing the cipher-algorithm input data to the cipher means, for producing, based upon the cryptographic algorithm being implemented, cryptographic algorithm output data from the cipher-algorithm output data, and for providing the cryptographic algorithm output data to the data output.

Implementations of such a device may include one or more of the following features. The network means are for selectively logically combining data based upon the cryptographic algorithm being implemented. The network means are configured to actuate a plurality of switches differently to implement the plurality of different cryptographic algorithms. The network means are configured to provide different combinations of data inputs to one or more logical signal combiners to implement the plurality of different cryptographic algorithms. The network means are configured to provide the different combinations of data inputs to effect values of respective variables in an initial-state encryption equation, a steady-state encryption equation, an initial-state decryption equation, and a steady-state decryption equation to implement the plurality of different cryptographic algorithms.

Also or alternatively, implementations of such a device may include one or more of the following features. The means for implementing further comprise authentication means, coupled to the network means, for determining an authentication tag associated with the cryptographic algorithm output data, the network means being further for providing a constant logical zero signal to the authentication means during a time when the cryptographic device is active but the authentication means are not determining the authentication tag. The means for implementing further comprise authentication means, coupled to the network means, for determining an authentication tag associated with the cryptographic algorithm output data, the network means and the authentication means sharing at least one switch and/or at least one logical signal combiner.

An example of a cryptographic method includes: receiving cryptographic algorithm input data at a cryptographic device; directing the cryptographic algorithm input data in the cryptographic device through a network of switches and logical signal combiners to produce cipher-algorithm input data; performing a cipher algorithm on the cipher-algorithm input data in a cipher circuit to produce cipher-algorithm output data; and directing the cipher-algorithm output data in the cryptographic device through the network of switches and logical signal combiners to produce cryptographic algorithm output data; where the cryptographic algorithm input data and the cipher-algorithm output data are directed through the network of switches and logical signal combiners based upon a selected cryptographic algorithm from a plurality of cryptographic algorithms implementable by different paths through the network of switches and logical signal combiners, with each path including the cipher circuit.

Implementations of such a device may include one or more of the following features. Directing the cryptographic algorithm input data, performing the cipher algorithm, and directing the cipher-algorithm output data implement values of respective variables in an initial-state encryption equation, a steady-state encryption equation, an initial-state decryption equation, and a steady-state decryption equation applicable to the plurality of different cryptographic algorithms to implement the selected cryptographic algorithm. The method further includes determining an authentication tag, associated with the cryptographic algorithm output data, using an authentication circuit to perform a one-way function. The method further includes providing a constant logical zero signal to the authentication circuit while the authentication circuit is idle. The authentication tag is determined using at least one logical signal combiner, in the network of switches and logical signal combiners, through which data pass in implementing the selected cryptographic algorithm.

Also or alternatively, implementations of such a device may include one or more of the following features. The cryptographic algorithm input data are first cryptographic algorithm input data, the cipher-algorithm input data are first cipher-algorithm input data, and the cryptographic algorithm output data are first cryptographic algorithm output data corresponding to a first cryptographic algorithm of the plurality of cryptographic algorithms, the method further comprising: receiving second cryptographic algorithm input data at the cryptographic device; directing the second cryptographic algorithm input data in the cryptographic device through the network of switches and logical signal combiners to produce second cipher-algorithm input data; performing the cipher algorithm on the second cipher-algorithm input data in the cipher circuit to produce second cipher-algorithm output data; and directing the second cipher-algorithm output data in the cryptographic device through the network of switches and logical signal combiners to produce second cryptographic algorithm output data corresponding to a second cryptographic algorithm of the plurality of cryptographic algorithms, the second cryptographic algorithm being different from the first cryptographic algorithm.

An example of a non-transitory, processor-readable storage medium includes processor-readable instructions configured to cause a processor to: receive cryptographic algorithm input data; receive an indication of a selected cryptographic algorithm from a plurality of different cryptographic algorithms; produce, based upon the selected cryptographic algorithm, cipher-algorithm input data from the cryptographic algorithm input data; perform a cipher algorithm on the cipher-algorithm input data to produce cipher-algorithm output data; and produce, based upon the cryptographic algorithm being implemented, cryptographic algorithm output data from cipher-algorithm output data.

Implementations of such a device may include one or more of the following features. The instructions configured to produce the cipher-algorithm input data and/or the instructions configured to cause the processor to produce the cryptographic algorithm output data are configured to cause the processor to selectively logically combine data based upon the selected cryptographic algorithm. The instructions configured to cause the processor to selectively logically combine data are configured to cause the processor to provide a particular combinations of data, based upon the selected cryptographic algorithm, to be logically combined. The instructions configured to cause the processor to provide the particular combination of data are configured to cause the processor to provide the particular combination of data to effect values of respective variables in an initial-state encryption equation, a steady-state encryption equation, an initial-state decryption equation, and a steady-state decryption equation to implement the selected cryptographic algorithm. The storage medium further includes instructions configured to cause the processor to determine an authentication tag associated with the cryptographic algorithm output data.

### BRIEF DESCRIPTION OF THE DRAWINGS

FIG. 1 is a simplified diagram of a wireless communication system.

FIG. 2 is a block diagram of components of a device shown in FIG. 1.

FIG. 3 is a state diagram for a state machine to implement multiple cryptographic modes.

FIG. 4 is a simplified circuit diagram of a cryptographic engine shown in FIG. 2.

FIG. 5 is a circuit diagram of the cryptographic engine shown in FIG. 2 showing signal flow for initial stage CBC mode encryption.

FIG. 6 is a circuit diagram of the cryptographic engine shown in FIG. 2 showing signal flow for subsequent-stage CBC mode encryption.

FIG. 7 is a circuit diagram of the cryptographic engine shown in FIG. 2 showing signal flow for initial stage CBC mode decryption.

FIG. 8 is a circuit diagram of the cryptographic engine shown in FIG. 2 showing signal flow for subsequent-stage CBC mode decryption.

FIG. 9 is a circuit diagram of the cryptographic engine shown in FIG. 2 showing signal flow for initial-stage CMAC authentication tag generation.

FIG. 10 is a circuit diagram of the cryptographic engine shown in FIG. 2 showing signal flow for initial-data-block CMAC authentication tag generation.

FIG. 11 is a circuit diagram of the cryptographic engine shown in FIG. 2 showing signal flow for intermediate-data-block CMAC authentication tag generation.

FIG. 12 is a circuit diagram of the cryptographic engine shown in FIG. 2 showing signal flow for final-data CMAC authentication tag generation.

FIG. 13 is a block flow diagram of a cryptographic method.

### DETAILED DESCRIPTION

Techniques are discussed herein for implementing multiple cryptographic modes using shared circuitry. For example, a single instance of a cipher circuit and/or a shared signal-modifying network can be used to implement multiple cryptographic modes. Input data may be selectively manipulated before being provided, as cipher-algorithm input data, to a cipher circuit such that while the cipher circuit performs the same cipher algorithm, different cipher-algorithm input data are produced by the selective manipulation such that different output data are produced for the same input data depending upon the cryptographic mode that is programmed to be performed. These examples, however, are not exhaustive.

Items and/or techniques described herein may provide one or more of the following capabilities, as well as other capabilities not mentioned. Multiple cryptographic modes may be implemented in a single interconnection network. Space, size, and/or cost may be reduced for providing multiple encryption mode capability. Future cryptographic modes may be accommodated without requiring a hardware change to a cryptographic engine. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

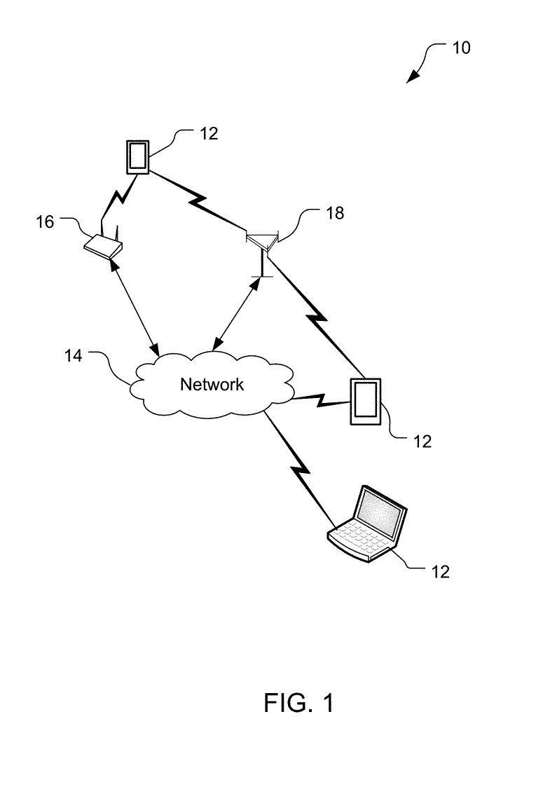

Referring to FIG. 1, a wireless communication system 10 includes various devices 12, here a smart phone, a tablet computer, and a laptop computer all in communication with a communications network 14. The devices 12 may each be configured to communicate with the network 14 directly and/or indirectly, wirelessly and/or through wired connections, e.g., through an access point 16 or a base station 18 (e.g., a cellular base station). The devices 12 may communicate through different mechanisms, e.g., Wi-Fi, cellular, etc., and may communicate different types of communications, e.g., voice, data, Internet data, etc. The devices 12, in order to provide different types of communication, may implement different cryptography types for the different communication types. The devices 12 shown in FIG. 1 are examples only and numerous other types of devices may be used including, but not limited to, Internet of Things (IoT) devices such as proximity sensors, camera sensors, remote locks, garage door openers, irrigation systems, weather sensors, etc.

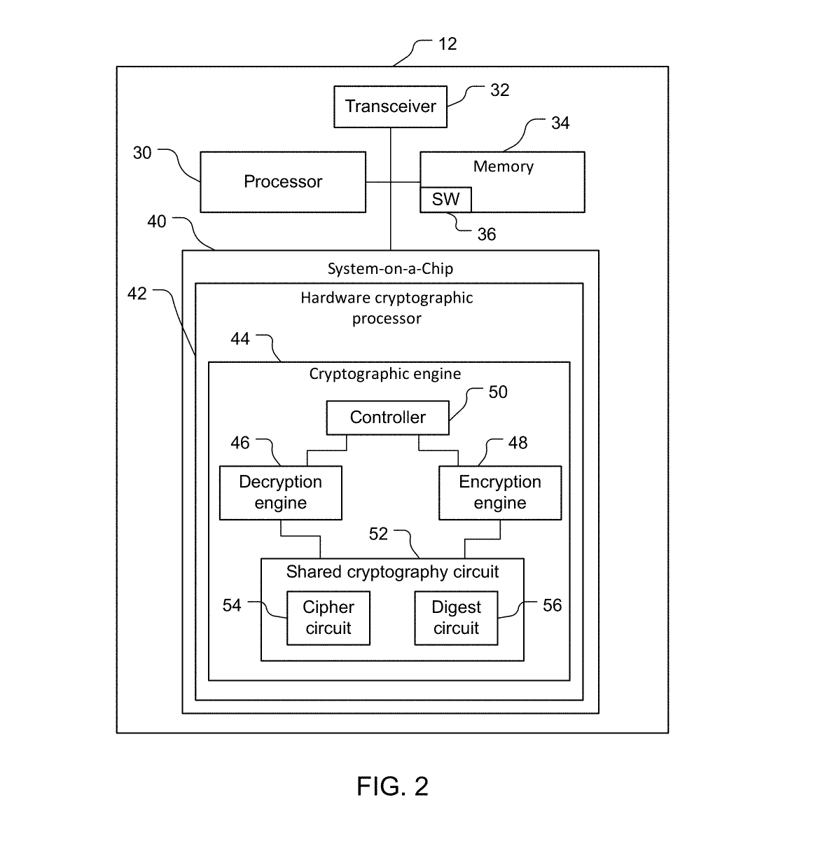

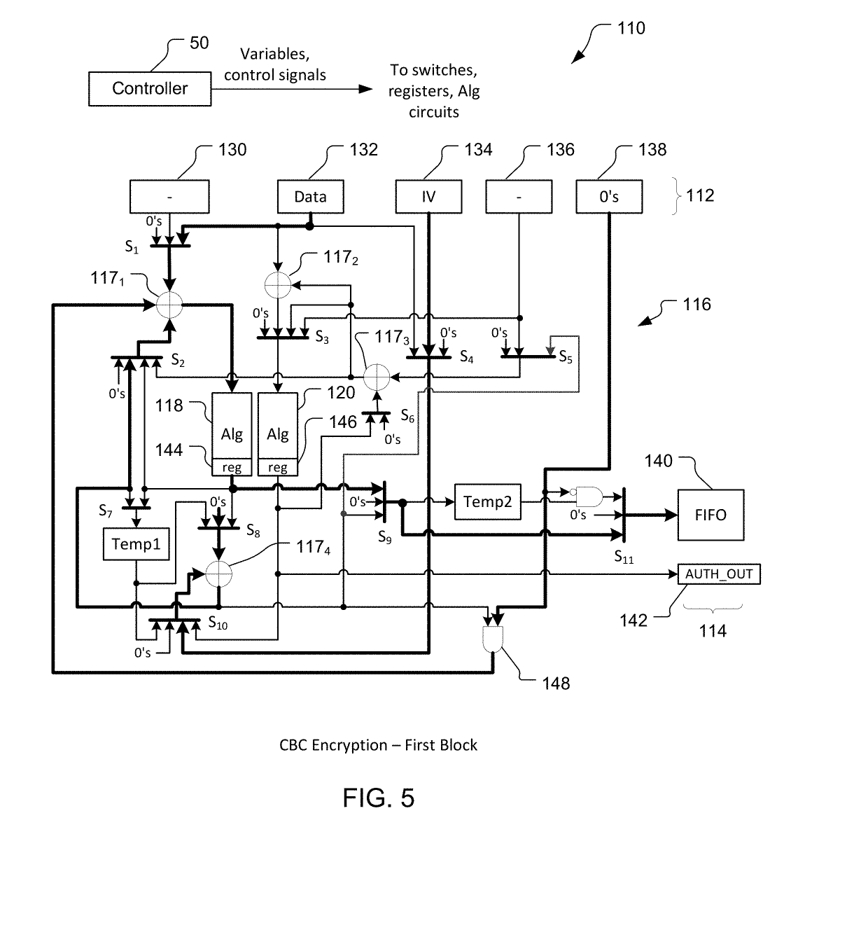

Referring also to FIG. 2, an example of the devices 12 shown in FIG. 1 includes a processor 30, a transceiver 32, a memory 34 including software (SW) 36, and a System-on-a-Chip (SoC) 40. The processor 30 may include multiple physical entities, and these entities may be physically distributed throughout the device 12. The transceiver 32 is communicatively coupled to the processor 30, the memory 34, and the SoC 40 and is configured to bi-directionally communicate with the network 14. The transceiver 32 may be configured to communicate with the network 14 through one or more wired connections and/or wirelessly, either directly (e.g., with the transceiver 32 including a modem) or indirectly (e.g., through the access point 16, through the base station 18, etc.). The processor 30 is preferably an intelligent hardware device, for example a central processing unit (CPU) such as those made or designed by QUALCOMM®, a microcontroller, an application specific integrated circuit (ASIC), etc. The memory 34 is communicatively coupled to the processor 30 and both the memory 34 and the processor 30 are communicatively coupled to the SoC 40. The SoC 40 includes a hardware cryptographic processor 42 that is communicatively coupled to the memory 34 and the processor 30. The cryptographic processor 42 includes a cryptographic engine 44 that includes a decryption engine 46, an encryption engine 48, and a controller 50. The software 36 may include processor-readable instructions configured to cause the processor 30 to perform functions discussed herein, e.g., programming the controller 50 to implement different cryptographic algorithms. For example, the software 36 may include processor-readable instructions configured to cause the processor 30 to process signals according to the discussion herein, e.g., regarding FIGS. 5-13 as well as to implement other cryptographic algorithms in accordance with the teachings herein.

The cryptographic engine 44, in particular the decryption engine 46 and the encryption engine 48, under control of the controller 50, is configured to implement multiple cryptographic algorithms (called modes or cryptographic modes) using a shared hardware, here a shared cryptography circuit 52. A mode as used herein is an algorithm for the cryptographic transformation of data that features a symmetric cipher algorithm. The controller 50 is configured to cause various data to be provided to the shared cryptography circuit, and to cause selective portions of the shared cryptography circuit to be used, in order to implement a selected cryptographic algorithm out of a set of different cryptographic algorithms that the cryptographic engine 44 is configured to implement. The shared cryptography circuit 52 is shown separately from the decryption engine 46 and the encryption engine 48, but is part of both the decryption engine 46 and the encryption engine 48 and thus shared by the decryption engine 46 and the encryption engine 48. The shared cryptography circuit 52 includes a cipher circuit 54 and a digest circuit 56.

The cipher circuit 54 is preferably, but not necessarily, a single instance of a circuit configured to perform a symmetric cipher algorithm. The cipher circuit 54 may have portions that are physically separate from each other, but the cipher circuit 54 is one collection of circuitry configured to perform a cipher algorithm. The device 12 could also have other circuitry to perform other functions, and may even have other cipher circuitry, but the multiple cryptographic algorithms can be implemented by the cipher circuit 54 in combination with other non-cipher circuitry without having other instances of the cipher circuitry. For example, the multiple cryptographic algorithms can be implemented without multiple separate circuits for implementing different modes, with the different circuits each having a cipher circuit of the same configuration (i.e., configured to implement the same cipher algorithm). The cipher circuit 54 is preferably configured to perform a cipher algorithm on input data to produce cipher-algorithm output data. While examples are discussed herein for operating on blocks of data, symmetric ciphers may be applied to blocks of data or streams of data and the discussion herein, including the various components discussed and the claims, includes both of these possibilities unless a possibility is explicitly excluded. The controller 50 is configured to control portions of the decryption engine 46 and the encryption engine 48 to use desired input data to produce cipher-algorithm input data, possibly by logically combining the input data, and to provide the cipher-algorithm input data to the cipher circuit 54. The controller 50 is further configured to control portions of the decryption engine 46 and the encryption engine 48 to use cipher-algorithm output data from the cipher circuit 54 to produce device output data, possibly by logically combining the cipher-algorithm output data with other data. The controller 50 is configured to selectively logically combine data based upon the cryptographic algorithm being implemented.

The digest circuit 56 is configured to produce an authentication tag associated with encrypted data produced by the encryption engine 48. The digest circuit 56 is configured to perform a digest algorithm, that preferably implements a one-way cryptographic function, on data input to the digest circuit 56. The one-way cryptographic function is irreversible, at least from a practical standpoint. The controller 50 is configured to control portions of the encryption engine 48 to use desired input data to produce digest input data, possibly by logically combining the input data based on the cryptographic algorithm being implemented, and to provide the digest input data to the digest circuit 56. The controller 50 is further configured to control portions of the encryption engine 48 to use digest output data from the digest circuit 56 as an authentication tag for corresponding cipher text.

The following table illustrates expressions for implementing several standard cryptographic algorithms.

TABLE 1

| | Encryption | | Decryption | |
|---|---|---|---|---|
| Mode | i = 0 | i > 0 | i = 0 | i > 0 |
| ECB | C₀ = Eₖ(P₀) | Cᵢ = Eₖ(Pᵢ) | P₀ = Dₖ(C₀) | Pᵢ = Dₖ(Cᵢ) |
| CBC | C₀ = Eₖ(P₀ ⊕ IV) | Cᵢ = Eₖ(Pᵢ ⊕ Cᵢ₋₁) | P₀ = Dₖ(C₀) ⊕ IV | Pᵢ = Dₖ(Cᵢ) ⊕ Cᵢ₋₁ |
| PCBC | C₀ = Eₖ(P₀) ⊕ IV | Cᵢ = Eₖ(Pᵢ ⊕ Pᵢ₋₁ ⊕ Cᵢ₋₁) | P₀ = Dₖ(C₀) ⊕ IV | Pᵢ = Dₖ(Cᵢ ⊕ Cᵢ₋₁ ⊕ Pᵢ₋₁) |
| CFB | C₀ = Eₖ (IV) ⊕ P₀ | Cᵢ = Eₖ (Cᵢ₋₁) ⊕ Pᵢ | P₀ = Dₖ (IV) ⊕ C₀ | Pᵢ = Dₖ (Cᵢ₋₁) ⊕ Cᵢ |
| OFB | C₀ = Eₖ (IV) ⊕ P₀ | Cᵢ = Eₖ (Cᵢ₋₁ ⊕ Eₖ(IV)) ⊕ Pᵢ | P₀ = Dₖ (IV) ⊕ C₀ | Pᵢ = Dₖ (Cᵢ₋₁ ⊕ Dₖ (IV)) ⊕ Cᵢ |
| CTR | C₀ = Eₖ(nonce \|\| IV) ⊕ P₀ | Cᵢ = Eₖ(nonce \|\| IV) ⊕ Pᵢ | P₀ = Dₖ(nonce \|\| IV) ⊕ C₀ | Pᵢ = Dₖ(nonce \|\| IV) ⊕ Cᵢ |

Table 1 shows expressions for processing an initial (i=0) and subsequent (i>0) blocks of data of a message according to cryptographic algorithms: ECB (Electronic Codebook), CBC (Cipher Block Chaining), PCBC (Propagating Cipher Block Chain), CFB (Cipher Feedback), OFB (Output Feedback), and CTR (Counter). Still other modes could be used, such as XCBC, EAX, CCM, XTS, GCM, F8, F9, etc. In Table 1, IV is an initialization vector, which may be a random number, and the symbol ⊕ indicates a logical XOR (exclusive-OR) operation. The expressions shown are for symmetric cryptography modes where a plaintext message P is decomposed into blocks of a uniform block size such that

P=P₀,P₁,P₂, . . . Pₙ₋₁ (1)

For 0≤n−1, the length of the plaintext block Pᵢ is the block size. If the length of the last plaintext block, Pₙ₋₁, is less than the block size, then appropriate padding is added to reach the block size. Further, in Table 1, Eₖ( )) and Dₖ( )) represent encryption and decryption functions, respectively, or a symmetric cipher with a shared secret k. Lastly, the cipher text indicated in Table 1 and resulting from encryption of the plaintext P may be expressed as

C=C₀,C₁,C₂, . . . ,Cₙ₋₁ (2)

The block size is the amount of data that the decryption engine 46 is configured to process to decrypt (or that the encryption engine 48 is configured to encrypt) at any one time. This amount of data may be of various sizes (e.g., 128 bits, 512 bits, etc.).

It has been discovered that the expressions in Table 1 may be condensed to fewer expressions that include variables (that may be set to various values to achieve a particular one of the expressions shown in Table 1). In particular, it has been found that the expressions in Table 1 may be reduced to the expressions shown below in Table 2.

TABLE 2

| | Encryption | | Decryption | |
|---|---|---|---|---|
| Mode | i = 0 | i > 0 | i = 0 | i > 0 |
| ECB, | C₀ = Eₖ(P₀ ⊕ X₀) ⊕ Y₀ | Cᵢ = Eₖ(Pᵢ ⊕ Xᵢ ⊕ Yᵢ) | P₀ = Dₖ(C₀) ⊕ S₀ | Pᵢ = Dₖ(Cᵢ ⊕ Sᵢ ⊕ Tᵢ) ⊕ Zᵢ |
| CBC, | | | | |
| PCBC | | | | |
| CFB, | C₀ = Eₖ (IV) ⊕ P₀ | Cᵢ = Eₖ (Cᵢ₋₁ ⊕ Xᵢ) ⊕Pᵢ | P₀ = Dₖ (IV) ⊕ C₀ | Pᵢ = Dₖ (Cᵢ₋₁ ⊕ Sᵢ) ⊕ Zᵢ |
| OFB, | | | | |
| CTR | | | | |

Each of the variables X, Y, Z, S, and T can be given an appropriate non-zero value, or a value of zero, in order to make the corresponding expression into one of the expressions in Table 1. A subscript of 0 indicates an initialization value of the variable, i.e., for an initial block of a message processed for the respective cryptographic algorithm and a subscript if i indicates a steady-state value for the variable, i.e., for any block, after the initial block, of a message for the respective cryptographic algorithm. Table 3 shows the values of the variables in FIG. 2 to implement the expressions in Table 1.

TABLE 3

| | variable | | | | | | | | | |
|---|---|---|---|---|---|---|---|---|---|---|
| mode | X₀ | Xᵢ | Y₀ | Yᵢ | Z₀ | Zᵢ | S₀ | Sᵢ | T₀ | Tᵢ |
| ECB | 0 | 0 | 0 | 0 | — | 0 | 0 | 0 | — | 0 |
| CBC | IV | Cᵢ₋₁ | 0 | 0 | — | Cᵢ₋₁ | IV | 0 | — | 0 |
| PCBC | 0 | Pᵢ₋₁ | IV | Cᵢ₋₁ | — | 0 | IV | Cᵢ₋₁ | — | Pᵢ₋₁ |
| CFB | — | 0 | — | — | — | Cᵢ | — | 0 | — | — |
| PFB | — | Eₖ(IV) | — | — | — | Cᵢ | — | Dₖ(IV) | — | — |
| CTR | — | Nonce \|\| | — | — | — | Cᵢ | — | Nonce \|\| | — | — |
| | | IV | | | | | | IV | | |

In Table 3, a dash (-) indicates that this variable is not used. The values of Xᵢ and Sᵢ for CTR mode being nonce ∥ IV indicate that the argument for the Eₖ and Dₖ functions, respectively, are nonce ∥ IV.

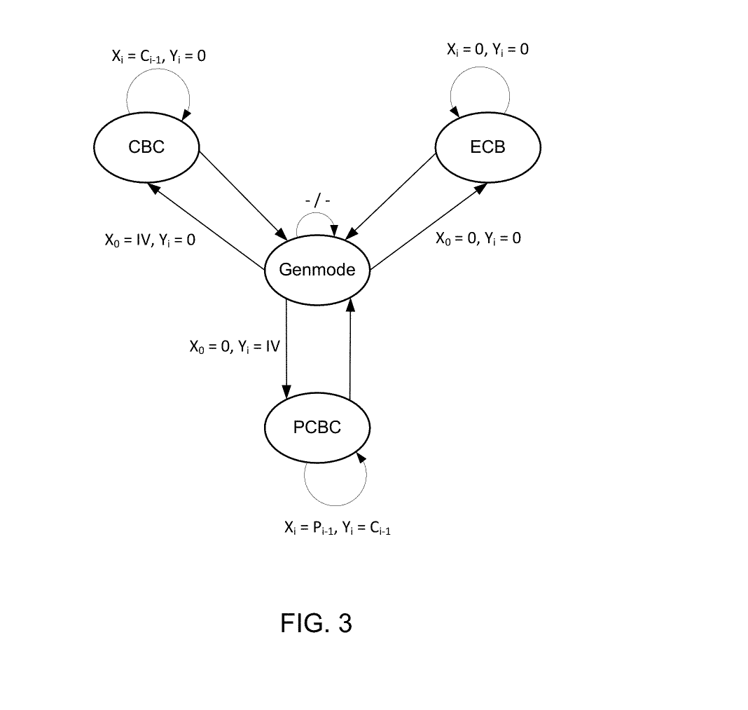

The controller 50 is configured to assign the values to the variables according to Table 3 to implement the desired cryptographic algorithm. The controller 50 may implement a finite state machine or a processor and software with instructions configured to be executed by the processor to perform the appropriate functions. Referring to FIG. 3, functional states of the controller 50 as a state machine include an idle state 70, an ECB encryption state 72, a CBC encryption state 74, and a PCBC encryption state 76. The states 72, 74, 76 are steady states, i.e., after initialization of the corresponding state. In FIG. 3, only encryption states are shown and only states for the ECB, CBC, and PCBC modes are shown for simplicity. The controller 50 is configured to set the values of the variables as shown in FIG. 3 and Table 3 to implement the cryptographic algorithms for encryption using the EBC, CBC, and PCBC modes. The controller 50 is further configured to set values of the variables as shown in FIG. 3 to implement cryptographic algorithms for decryption using the EBC, CBC, and PCBC modes, and to implement the cryptographic algorithms for encryption and decryption using the CFB, OFB, and CTR modes. Alternatively, the controller 50 could be configured to implement fewer than all six of the modes shown in Table 3, and/or may be configured to implement one or more other modes not discussed.

It has further been discovered that the expressions in Table 2 may be condensed to fewer expressions that include variables that may take on plaintext, cipher text, or initialization vector values. In particular, it has been found that the expressions in Table 2 may be reduced to the expressions shown below in Table 4.

TABLE 4

| | Encryption | | Decryption | |
|---|---|---|---|---|
| Mode | i = 0 | i > 0 | i = 0 | i > 0 |
| ECB, CBC, | C₀ = Eₖ(A₀ ⊕ X₀) ⊕ Y₀ | Cᵢ = Eₖ(Aᵢ ⊕ Xᵢ) ⊕ Yᵢ | P₀ = Dₖ(B₀) ⊕ S₀ | Pᵢ = Dₖ(Bᵢ ⊕ Sᵢ ⊕ Tᵢ) ⊕ Zᵢ |
| PCBC, CFB, | | | | |
| OFB, CTR | | | | |

In this case, the values of A and B may be plaintext, cipher text, and IV, etc., and values of X, Y, Z, S, and T are assigned as appropriate to achieve the desired expression shown in Table 1. The controller 50 may be configured to provide the appropriate values of the variables to implement a desired mode.

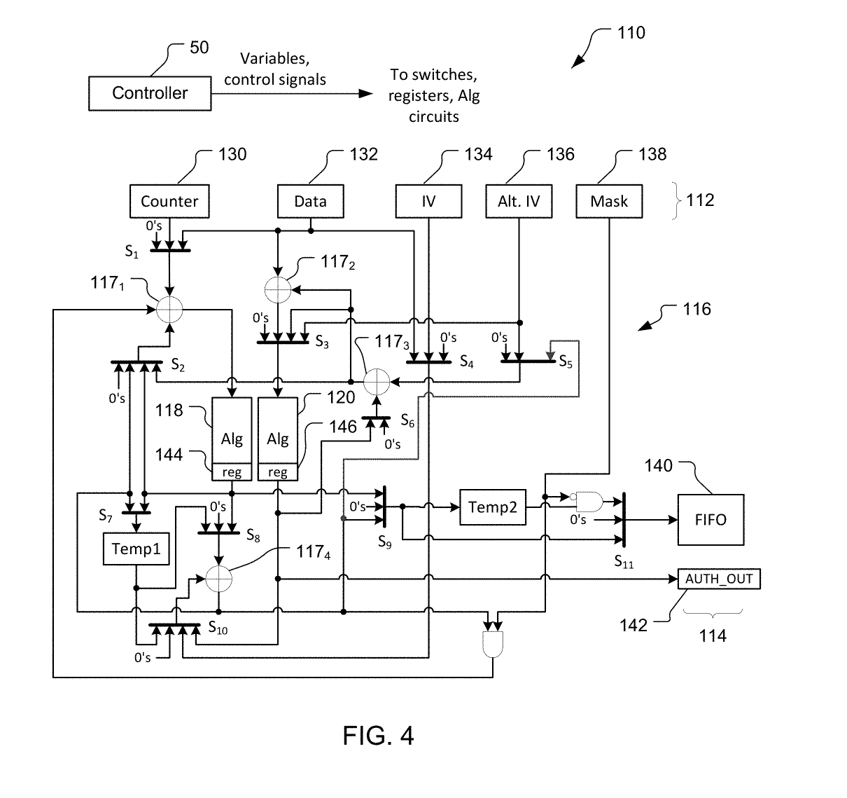

Referring to FIG. 4, with further reference to FIG. 2, a cryptographic engine 110 that is an example of the cryptographic engine 44 includes a data input 112, a data output 114, a network 116, a cipher circuit 118, and a digest circuit 120. Not all of the components of, or connections between components in, the cryptographic engine 110 are shown in FIG. 4 (or FIGS. 5-12 below, some of which show features not shown in other figures). The data input 112 includes a counter sub-input 130, a data sub-input 132, an initialization vector sub-input 134, an alternative initialization vector sub-input 136, and a mask sub-input 138. The data output 114 includes a data sub-output 140 (here a FIFO (first in, first out) register), and an authentication sub-output 142. The network 116 is coupled to the data input 112 and the data output 114 and includes multiple switches S₁₋₁₁, here multiplexers (MUXes), and multiple logical signal combiners 117₁₋₄, here exclusive-OR (XOR) gates. The network 116 is configured to route data from the data input 112, possibly combining data along the way, to the cipher circuit 118 and the digest circuit 120, to route data from the cipher circuit 118, possibly combining data along the way, back to the cipher circuit 118 and/or to the data output 114, and to route data from the digest circuit 120 to the data output 114 and/or back to the digest circuit 120, possibly combining data along the way. The network 116 is configured to manipulate data that is provided to the cipher circuit 118 and/or data output by the cipher circuit 118 differently to implement different cryptographic algorithms. The network 116 is preferably a single instance of the components shown that is shared between implementations of different cryptographic algorithms. Multiple instances of the network components could be used, but the discussion herein focuses on a single instance of the network components being used. The network 116 may be considered a single network, common to the multiple cryptographic algorithm implementations using the cipher circuit 118. The cipher circuit 118 is an example of the cipher circuit 54 shown in FIG. 2 and is configured to perform a symmetrical block cipher algorithm. The digest circuit 120 is an example of the digest circuit 56 shown in FIG. 2 and is configured to perform a one-way function such as a hash function. The digest circuit 120 here is configured to process a block of data at a time.

The network 116 is configured to provide a constant logical zero signal to various components. For example, the network 116 may provide a logical signal to the cipher circuit 118 or the digest circuit 120 when device 12, and in particular the cryptographic engine 44, is active but the cipher circuit 118 or the digest circuit 120 is idle and thus not producing ciphertext, plaintext, or an authentication tag, respectively. By providing a constant logical zero signal to the cipher circuit 118 or the digest circuit 120, prevents the cipher circuit 118 or the digest circuit 120 from seeing a variable data on its respective input, and thus prevents power consumption corresponding to the cipher circuit 118 or the digest circuit 120 processing the variable data. The constant logical zero signal may have a voltage that varies over time but that stays within a range corresponding to a logical zero, i.e., does not change in logical value. For example, a signal may be considered a logical zero if it's voltage is at or below 0.5 V. In this example, the constant logical zero signal may vary in value from 0 V to 0.5 V and still be considered a constant logical zero signal. The network 116 may provide a logical zero signal to a multiplexer when the output of the multiplexer is not being used.

The data input 112 is configured to receive several types of information and to provide the information to the network 116. The counter sub-input 130 may be a passive input that receives a counter value or may be a counter that generates and provides a counter value. The data sub-input 132 is coupled and configured to receive plaintext messages to be encrypted and cipher text messages to be decrypted. The initialization vector sub-input 134 may be a passive input that receives an initialization vector or may be a device configured to generate and provide an initialization vector. For example, the initialization vector sub-input 134 may be a random-number generator or a pseudo-random-number generator and the initialization vector may be a random number or a pseudo-random number (or other value). The alternative initialization vector sub-input 136 may be a passive input that receives an alternative initialization vector or may be a device configured to generate and provide an alternative initialization vector. The mask sub-input 138 may be a passive input that receives a mask value or may be a device configured to generate and provide a mask value.

The network 116 is configured to convey and manipulate data from the data input 112 to the cipher circuit 118 and the digest circuit 120, from the cipher circuit 118 to the data output 114 and/or to the cipher circuit 118, and from the digest circuit 120 to the data output 114 and/or the digest circuit 120. The network 116 is configured to convey data from any of the sub-inputs 130, 132, 134, 136, 138 to the cipher circuit 118 and/or the digest circuit 120 as appropriate. For example, the network 116 may route plaintext from the data sub-input 132 and/or an initialization vector from the initialization vector sub-input 134 to the cipher circuit 118. The network 116 may logically combine the plaintext and/or the initialization vector with each other and/or with other data to form cipher-algorithm input data and provide the cipher-algorithm input data to the cipher circuit 118. Alternatively, the network 116 may provide data from the data sub-input 132 (e.g., plaintext or cipher text) or from the initialization vector sub-input 134 to the cipher circuit 118 without altering any of these data, e.g., without logically combining the data (e.g., plaintext, cipher text, initialization vector) with any other data. The network 116 may route and/or logically combine data from others of these sub-inputs 130, 132, 134, 136, 138 to produce the cipher-algorithm input data and/or to produce digest input data and provide the digest input data to the digest circuit 120. Further, the network 116 is configured to convey an output of the digest circuit 122 to the authentication sub-output 142 and/or back to the digest circuit 120. For example, the network 116 may store results of the processing by the cipher circuit 118 in a register 144 and store results of the processing of the digest circuit 120 in a register 146. The network 116 is also configured to convey data output from the cipher circuit 118, e.g., as stored in the registers 144, 146, to the data sub-output 140 and/or back to the cipher circuit 118. While routing the data output from the cipher circuit 118, the network 116 may logically combine the data output from the cipher circuit 118 with other data, such as mask data from the mask sub-input 138, before providing the data to the data sub-output 140.

To convey the data from the data input 112 to the cipher circuit 118 and/or the digest circuit 120, and from the cipher circuit 118 and/or the digest circuit 122 the data output 114 and/or back to the cipher circuit 118 or the digest circuit 120, respectively, the network 116 routes the data through one or more of the logical signal combiners 117 and one or more of the switches S (here multiplexers) as appropriate. The network 116 is configured such that these logical signal combiners 117 and these switches S can provide cipher-algorithm input data to the cipher circuit 118, which is a single instance of a cipher circuit, and to provide device output data to the data output 114 using cipher-algorithm output data from the cipher circuit 118. The network 116, in combination with the single instance of the cipher circuit 118, is configured to implement the different cryptographic algorithms implementable by the cryptographic engine 44, with each of the cryptographic algorithms including the cipher algorithm that the single instance of the cipher circuit 118 is configured to perform.

The network 116 includes the controller 50 which is configured to be programmed to actuate the switches S in the network 116 to route data and to cause the logical combinations of data. The controller 50 is configured to be programmed to actuate the switches S differently to implement the different cryptographic algorithms. In particular, the controller 50 is configured to be programmed to actuate the switches S differently to cause different logical combinations of signals in the logical signal combiners 117 to provide different cipher-algorithm input data from the data input 112 to the cipher circuit 118. Also or alternatively, the controller 50 may cause different logical combinations of cipher-algorithm output data from the cipher circuit 118 to provide device output data to the data output 114, and in particular the data sub-output 140, and (as appropriate) back to the cipher circuit 118, to implement the different cryptographic algorithms. The controller 50 may be configured to be programmed to actuate the switches S differently to affect values of respective variables and equations representing the different cryptographic algorithms, e.g., as shown in Table 2 and Table 4, to implement the different cryptographic algorithms. In particular, the controller 50 may be configured to be programmed to actuate the switches S to affect values of respective variables in an initial-state encryption equation, a steady-state encryption equation, an initial-state decryption equation, and a steady-state decryption equation to implement the different cryptographic algorithms. Further, the network 116 is configured such that the network 116 and the cipher circuit 118 may implement the different cryptographic algorithms without forming an unregulated loop.

The network 116 is also configured to provide, in accordance with control signals from the controller 50, data to the digest circuit 120 to provide an authentication mechanism for producing an authentication tag, e.g., corresponding to cipher text produced by the cipher circuit 118. The digest circuit 120 is configured to perform a one-way function on received data. The network 116 is preferably configured to feedback output of the digest circuit 120 until all the data to be authenticated has been processed, yielding an authentication tag that is smaller than the data being authenticated, and preferably an authentication tag of the same size regardless of the size of the authenticated data message.

Referring to FIG. 5, with further reference to FIGS. 2 and 4, the controller 50 can selectively actuate the switches S to implement encryption of an initial block of plaintext according to the CBC cryptographic mode. The controller 50 is configured to cause each of the switches S noted below to connect the appropriate input to the output of the respective switch S to make the appropriate connections and provide the data routing as discussed below. For simplicity, however, it is not stated each time that the controller 50 is configured to cause, or causes, the respective switch S to select the appropriate input and connect the selected input to the output of the respective switch S. It may simply be stated that the network 116 routes the data, or that data flows as shown in the figure, or that a respective switch S routes the data, etc. A plaintext message is received at the data sub-input 132 and the first block of plaintext is provided to the switch S. While the plaintext is also provided to the switch S₄, the controller 50 causes the switch S₄ not to select the switch input from the data sub-input 132. The switch S₁ selects the switch input connected to the data sub-input 132 and provides the plaintext data to the output of the switch S₁, with this output being connected to the logical signal combiner 117₁. The network 116 routes an initialization vector (IV) from the initialization vector sub-input 134 through the switch S₄ and the switch S₁₀ to the logical signal combiner 117₄. Logical zeroes are supplied to the switch S₈ and by the switch S₈ to the logical signal combiner 117₄. Supplying logical zeroes to the logical signal combiner 117₄, here an exclusive-OR gate, causes the logical signal combiner 117₄ to act as a pass-through, not changing the data received from the switch S₁₀ to the output of the logical signal combiner 117₄, such that data provided to the logical signal combiner 117₄ is the same as the data output by the logical signal combiner 117₄. Consequently, the network 116 routes the initialization vector to the switch S₂ and on to the logical signal combiner 117₁. Logical zeroes are provided from the mask sub-input 138 to an AND gate 148, and thus logical zeroes are provided to a third input of the logical signal combiner 117₁ such that only the data from the switches S₁ and S₂ affect the output of the logical signal combiner 117₁. The logical signal combiner 117₁ combines the initialization vector with the plaintext received from the switch S₁ and provides the logically-combined output as cipher-algorithm input data to the cipher circuit 118. The cipher circuit 118 performs the cipher algorithm on the cipher-algorithm input data and provides the resulting output data, in this case encrypted data that is a block of cipher text, to the register 144. The network 116 routes the block of cipher text from the register 144 through the switch S₉ to the switch S₁₁ and through the switch S₁₁ to the data sub-output 140.

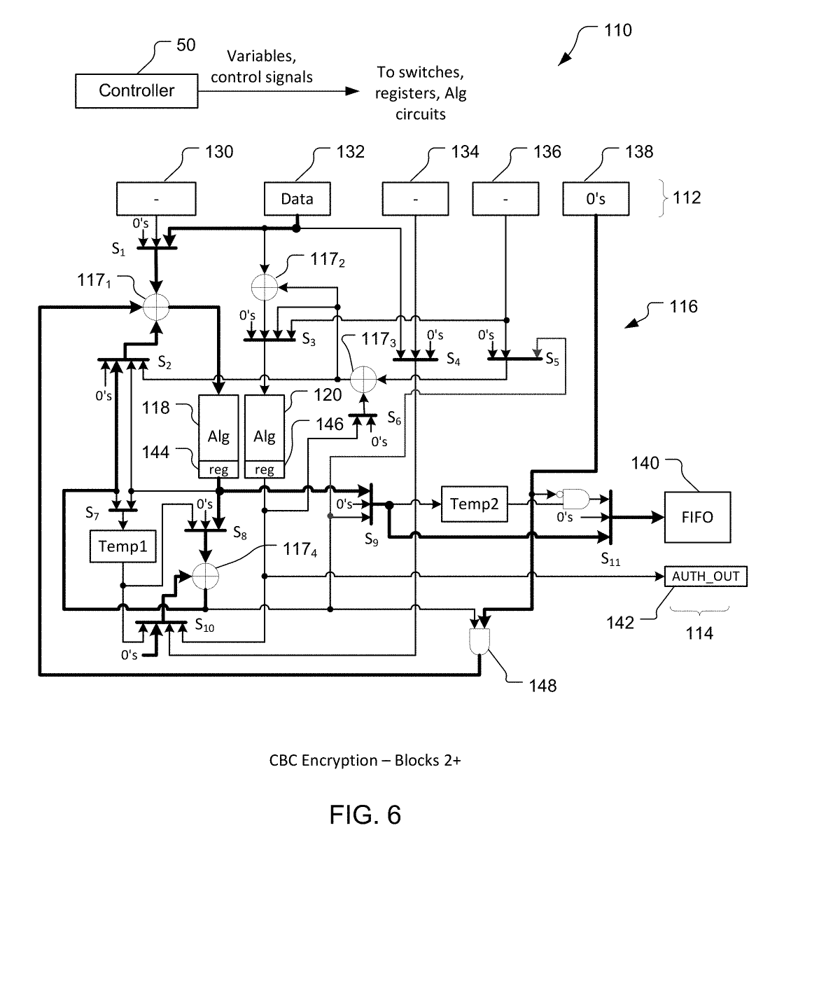

Referring to FIG. 6, with further reference to FIGS. 2, 4 and 5, the controller 50 can selectively actuate the switches S to implement encryption of further blocks (i.e., beyond the initial block) of plaintext according to the CBC mode. Similar to FIG. 5, the network 116 routes each block of cipher text from the register 144 through the switch S₉ to the switch S₁₁ and through the switch S₁₁ to the data sub-output 140. Also similar to FIG. 5, logical zeroes are provided from the mask sub-input 138 to the AND gate 148 and blocks of plaintext data are provided by the network 116 from the data sub-input 132 through the switch S₁ to the logical signal combiner 117₁. Contrary to FIG. 5, however, the secondary input to the logical signal combiner 117₁ originates from the register 144. The network 116 routes the previous block of cipher text stored in the register 144 through the switch S₈ to the logical signal combiner 117₄. Logical zeroes are provided through the switch S₁₀ to the logical signal combiner 117₄ such that the logical signal combiner 117₄ acts as a pass-through for the cipher text to be provided to the logical signal combiner 117₁ through the switch S₂. Thus, the most-recent cipher text is used to produce the present cipher text, as reflected in the expression for CBC encryption for i>0 shown in Table 1.

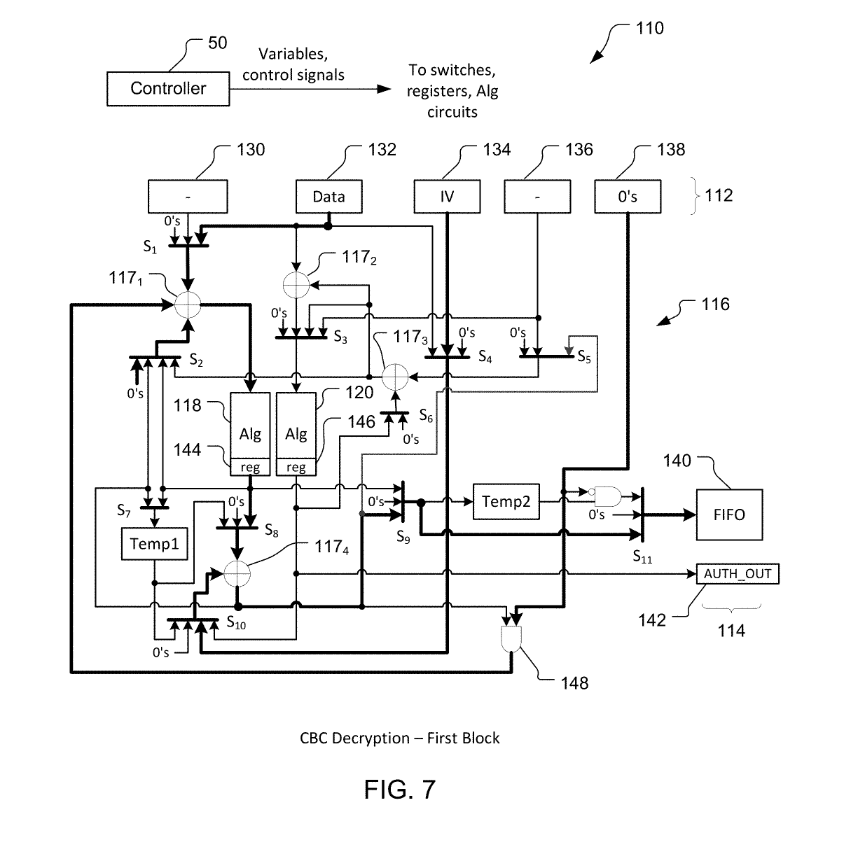

Referring to FIG. 7, with further reference to FIGS. 2 and 4, the controller 50 can selectively actuate the switches S to implement decryption of an initial block of cipher text according to the CBC mode. A cipher text message is received at the data sub-input 132 and the first block of the cipher text is provided through the switch S₁ to the logical signal combiner 117₁. Logical zeroes are supplied to the switch S₂ and by the AND gate 148 to the logical signal combiner 117₁ and the logical signal combiner 117₁ consequently passes the first block of cipher text as cipher-algorithm input data to the cipher circuit 118. The cipher circuit 118 performs the cipher algorithm on the cipher-algorithm input data and provides the resulting cipher-algorithm output data to the register 144. The network 116 routes the block of cipher-algorithm output data from the register 144 through the switch S₈ to the logical signal combiner 117₄. The network 116 routes an initialization vector from the initialization vector sub-input 134 through the switch S₄ and the switch S₁₀ to the logical signal combiner 117₄. The logical signal combiner 117₄ combines the cipher-algorithm output data from the register 144 with the initialization vector and routes the resulting plaintext block through the switch S₉ and the switch Sᵢᵢ to the data sub-output 140.

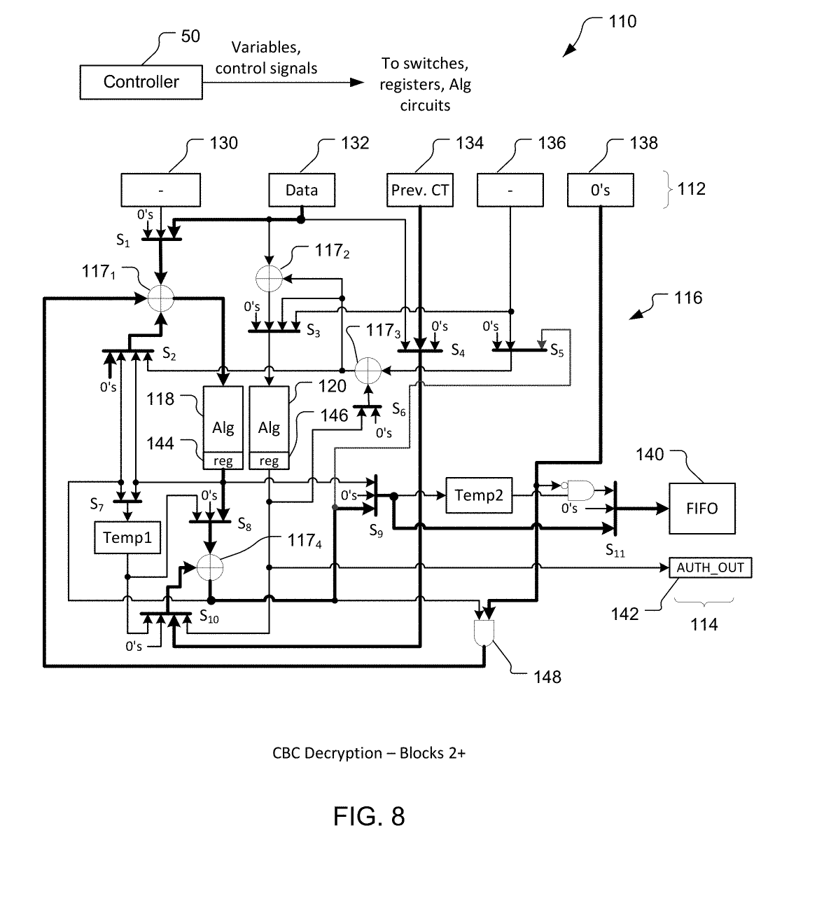

Referring to FIG. 8, with further reference to FIGS. 2, 4 and 7, the controller 50 can selectively actuate the switches S to implement decryption of further blocks (i.e., beyond the initial block) of cipher text according to the CBC mode. The controller 50 causes the network 116 to process further cipher text blocks from the data sub-input 132 similarly to the processing shown in FIG. 7, except that instead of an initialization vector being provided at the initialization vector sub-input 134, the immediately-prior block of cipher text is provided to the initialization vector sub-input 134. Consequently, the immediately-prior cipher text block (i.e., the last cipher text block processed before the present cipher text block being processed) is logically combined (here exclusive-ORed) with the present cipher-algorithm output data to produce the device output data provided to the data sub-output 140.

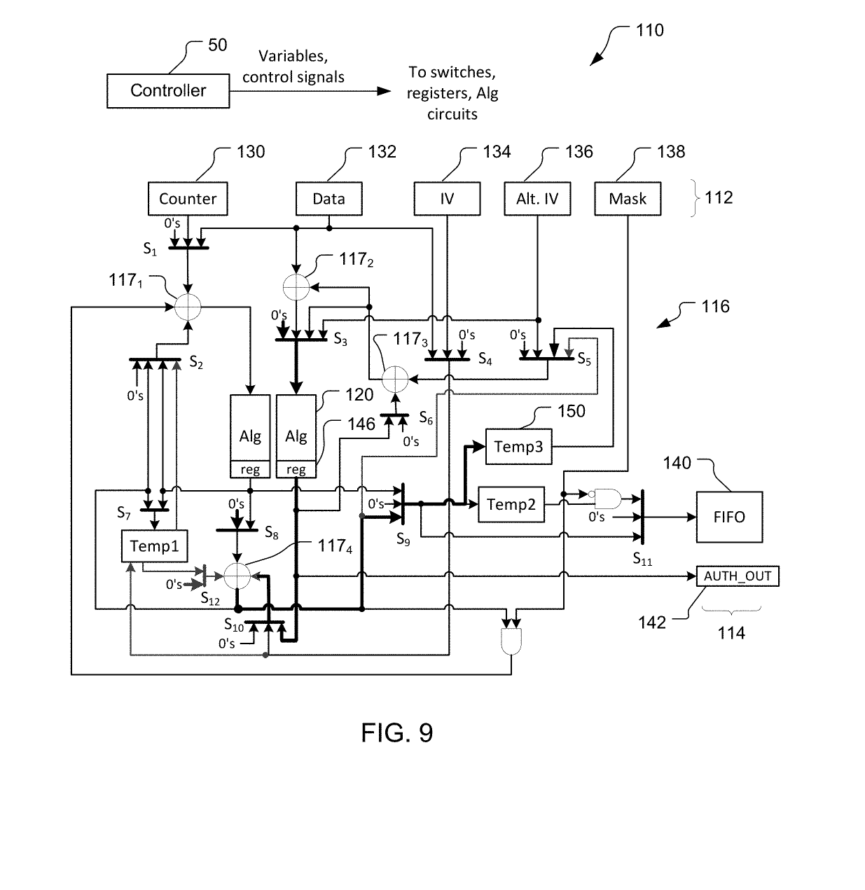

Referring to FIGS. 9-13, the cryptographic engine 110 may authenticate data by determining an authentication tag. The authentication process may be repeated to produce a verification authentication tag when the data are to be used and the data only used if the original authentication tag and the verification authentication tag match. That is, the original authentication tag and the verification (recreated) authentication tag may be compared, e.g., by the processor 30 and the data from which the verification authentication data was produced will only be used if the original authentication tag and the verification authentication tag are identical. FIGS. 9-12 illustrate use of the cryptographic engine 110 to produce an authentication tag in accordance with a CMAC (Cipher-Based Message Authentication Code) protocol. The authentication tag may be produced using any amount of data, for example the cipher text stored for later retrieval and use. In this way, the authentication tag may be used to verify that the stored cipher text has not been modified. A portion of the cryptographic engine 110 for performing encryption and/or decryption may share one or more components (e.g., one or more switches and/or one or more logical signal combiners) with a portion of the cryptographic engine 44 for performing authentication (e.g., determining an authentication tag).

Referring to FIG. 9, the controller 50 can selectively actuate the network 116 to implement encryption of 0's in accordance with the CMAC protocol. The controller 50 causes the network 116 to provide logical 0's to the digest circuit 120 through the switch S₃. The digest circuit 120 processes the 0's in accordance with the digest algorithm and outputs corresponding digest output data. As the digest output data was determined by processing 0's, the digest output data are labeled, here, 0's digest output data. The controller 50 further causes the network 116 to route the 0's digest output data through the switch S10 to the logical signal combiner 117₄. The controller 50 causes the logical signal combiner 117₄ to be supplied by the 0's digest output data and 0's through the switches S₈, S₁₂ such that the 0's digest output data is passed, unchanged, through the logical signal combiner 117₄. The controller 50 causes the 0's digest output data to be provided to a temporary-data storage device 150.

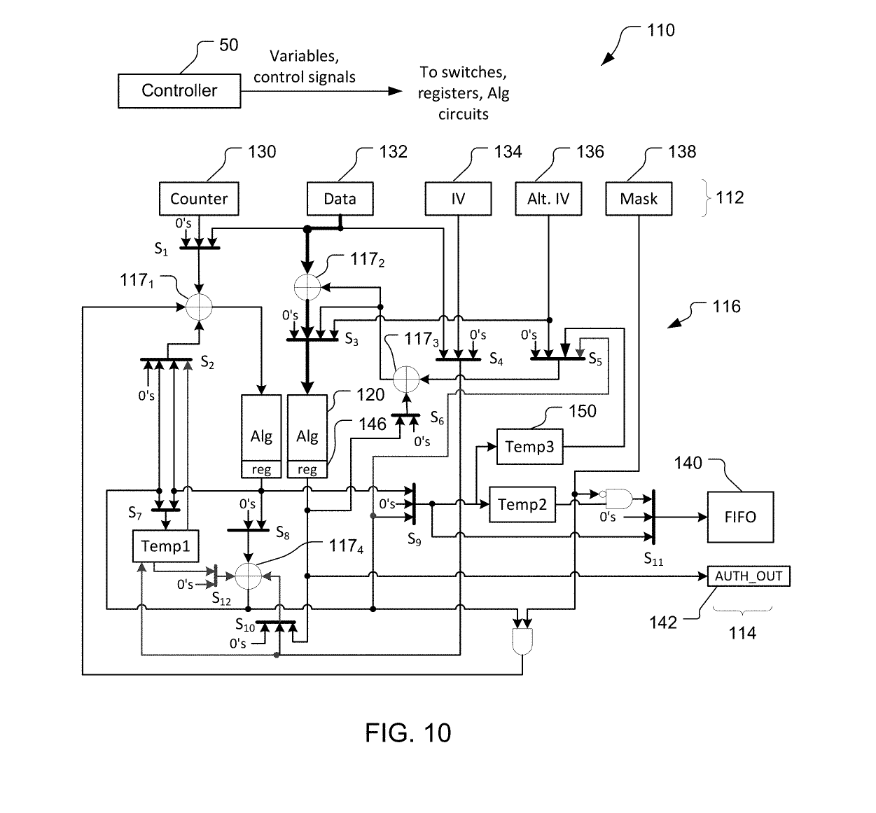

Referring to FIG. 10, the controller 50 can selectively actuate the network 116 to process a first block of data to be authenticated in accordance with the CMAC protocol. The controller 50 causes the network 116 to provide a block of data to the digest circuit 120 from the data sub-input 132 through the logical signal combiner 117₂ (by supplying the other input(s) of the logical signal combiner 117₂ with logical 0's, the circuitry for which is omitted from FIG. 10 for simplicity and clarity) and through the switch S₃. The digest circuit 120 processes the block of data in accordance with the digest algorithm and outputs corresponding digest data to the register 146.

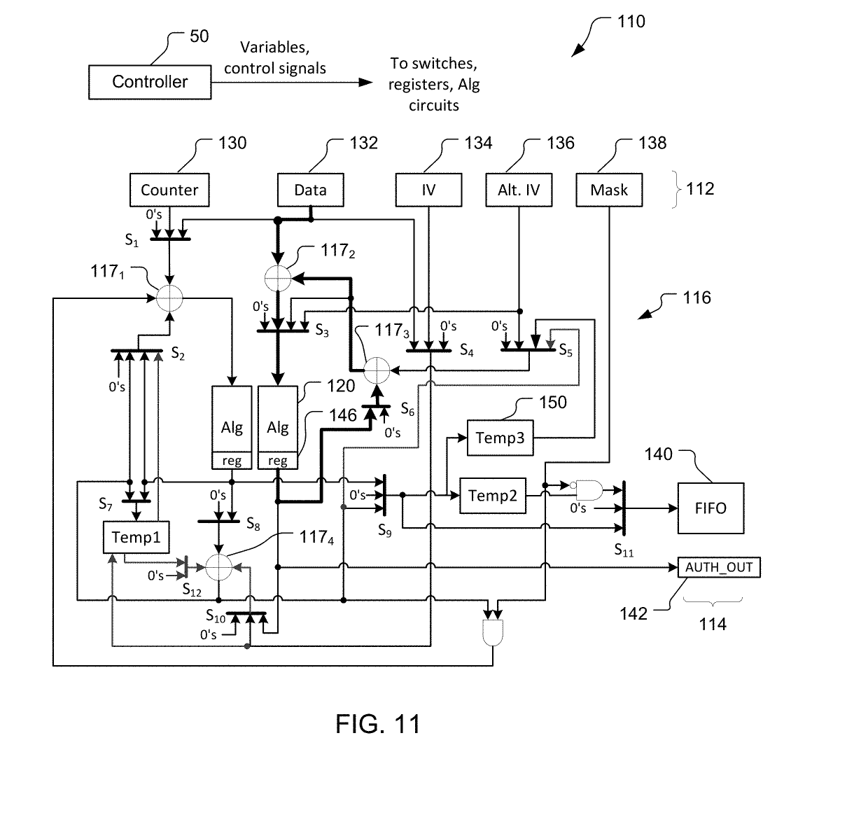

Referring to FIG. 11, the controller 50 can selectively actuate the network 116 to process subsequent blocks of data (after the first block of data and before a last block of data) to be authenticated in accordance with the CMAC protocol. The controller 50 causes the network 116 to provide a block of data to the logical signal combiner 117₂ and to supply a previous (the most-recently determined) digest output block of data to the logical signal combiner 117₂ through the switch S₆ and the logical signal combiner 117₃. The logical signal combiner 117₂ combines these two blocks of data and provides the combined data block through the switch S₃ to the digest circuit 120. The digest circuit 120 processes the combined block of data in accordance with the digest algorithm and outputs corresponding digest data to the register 146.

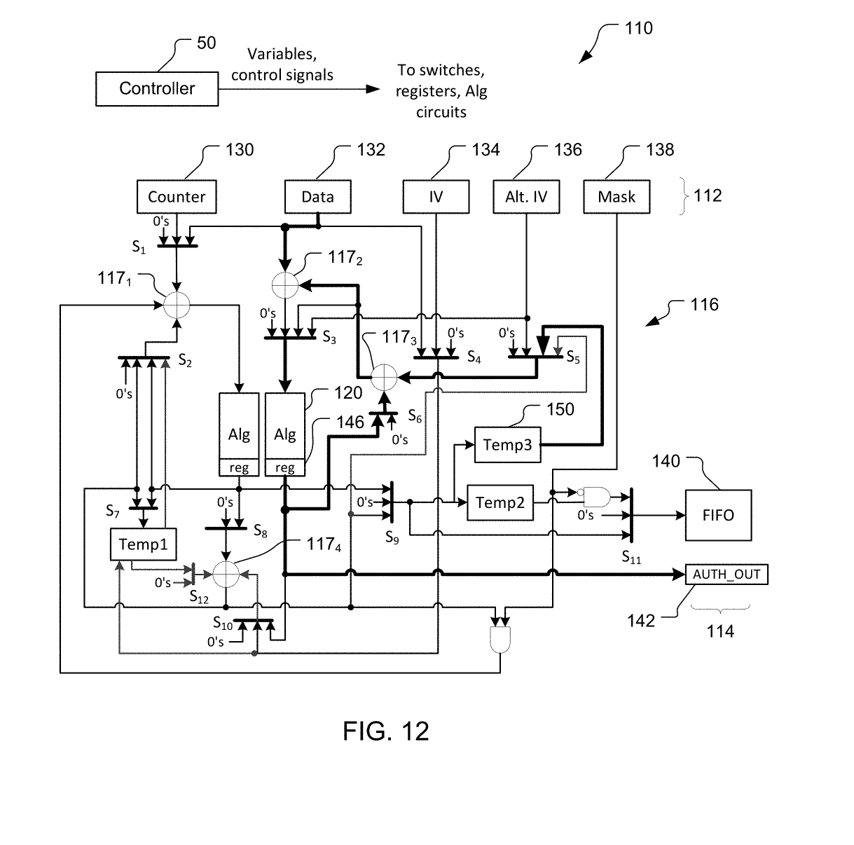

Referring to FIG. 12, the controller 50 can selectively actuate the network 116 to process a final amount of data to be authenticated in accordance with the CMAC protocol. The final amount of data may be a full block of data (i.e., of the size of data processable by the digest circuit 120) or less than a full block of data. If the final amount of data is less than a full block, then 0's may be added to the final amount of data to reach a full block size. The controller 50 causes the network 116 to provide the final data, of the set of data to be authenticated, to the logical signal combiner 117₂. The controller 50 causes the network 116 to supply a previous (the most-recently determined, here the pen-ultimate) digest output block of data to the logical signal combiner 117₃ through the switch S₆. The controller 50 also causes the network 116 to provide the 0's digest output data from the temporary-data storage device 150 to the logical signal combiner 117₃. The 0's digest output data may be processed by logic (not shown) inside the temporary-data storage device 150. The logic used to process the 0's digest output data may be different depending upon whether the final amount of data is a full block size or less than a full block size. The controller 50 causes the output of the temporary-data storage device 150 to be supplied to the logical signal combiner 117₃ through the switch S₅. The logical signal combiner 117₃ combines the last digest output data with the data from the temporary-data storage device 150 and provides these combined data to the logical signal combiner 117₂. The logical signal combiner 117₂ combines these combined data with the final amount of data and provides these combined data to the digest circuit 120 through the switch S₃. The digest circuit 120 processes the combined block of data in accordance with the digest algorithm and outputs an authentication tag that is provides to the authentication sub-output 142. The authentication tag is stored in association with authenticated data for later retrieval and comparison with a verification authentication tag produced using the authenticated data (or what is believed to be the authenticated data) to determine whether the authenticated data has been altered since being stored.

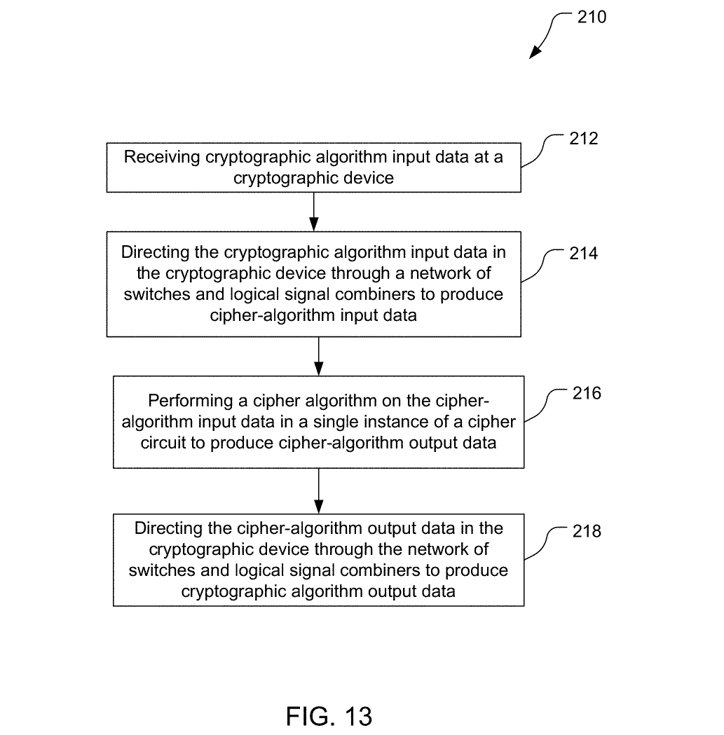

Referring to FIG. 13, with further reference to FIGS. 1-12, a cryptographic method 210 includes the stages shown. The method 210 is, however, an example only and not limiting. The method 210 may be altered, e.g., by having stages added, removed, rearranged, combined, performed concurrently, and/or having single stages split into multiple stages.

At stage 212, the method 210 includes receiving cryptographic algorithm input data at a cryptographic device. For example, counter data, plaintext, cipher text, an initialization vector, an alternative initialization vector, and/or mask data may be received by the data input 112 of the device 12. Receiving the cryptographic algorithm input data may include producing the cryptographic algorithm input data, e.g., producing a counter value, producing a random number or pseudorandom number as an initialization vector or alternative initialization vector.

At stage 214, the method 210 includes directing the cryptographic algorithm input data in the cryptographic device through a network of switches and logical signal combiners to produce cipher-algorithm input data. For example, the network 116 selectively routes data from the data input 112 through one or more of the switches S and one or more of the logical signal combiners 117 to produce cipher-algorithm input data. Which data are routed through which switch(es) S and through which logical signal combiner(s) 117 and whether the data are altered or not by the logical signal combiner(s) 117 is controlled by the controller 50 selectively actuating (i.e., actuating or not actuating) the switch(es) S, and selectively actuating (i.e., actuating or not actuating) one or more data sub-inputs such as the counter sub-input 130. The different routing and logical combinations produce the cipher-algorithm input data in accordance with the selected cryptographic algorithm, which may be programmed, e.g., either by programming a state machine or by programming software that is executed by a processor.

At stage 216, the method 210 includes performing a cipher algorithm on the cipher-algorithm input data in a single instance of a cipher circuit to produce cipher-algorithm output data. For example, the cipher circuit 118 processes the cipher-algorithm input data according to a cipher algorithm that the cipher circuit 118 is configured to perform. The cipher algorithm is preferably a symmetric cipher algorithm in which case the cipher circuit 118 ciphers a block of the cipher-algorithm input data, forming cipher text from plain text, or forming plaintext from cipher text, or transforming cipher text into text that may be further manipulated into plaintext, e.g., by logically combining the text with further data. The cipher algorithm is performed using the cipher circuit 118 regardless of which of multiple cryptographic algorithms (modes) is being implemented. Thus, the cipher algorithm for multiple modes is performed without using separate physical cipher circuits each of which can perform the same cipher algorithm.

At stage 218, the method 210 includes directing the cipher-algorithm output data in the cryptographic device through the network of switches and logical signal combiners to produce cryptographic algorithm output data. For example, the network 116 routes a block of data output from the cipher circuit 118 from the register 146 to the data sub-output 140 of the data output 114. In other examples, the network 116 may route the cipher-algorithm output data through one or more switches and/or one or more logical signal combiners as appropriate for an implemented cryptographic algorithm.

The cryptographic algorithm input data and the cipher-algorithm output data are directed through the network of switches and logical signal combiners based upon a selected cryptographic algorithm from multiple cryptographic algorithms implementable by different paths through the network, with each path including the single instance of the cipher circuit. Thus, multiple different cryptographic algorithms may be implemented by routing data through the network differently, combining data logically as appropriate for the particular cryptographic algorithm being implemented. For example, directing the cryptographic algorithm input data, performing the cipher algorithm, and directing the cipher-algorithm output data implement values of respective variables in an initial-state encryption equation, a steady-state encryption equation, an initial-state decryption equation, and a steady-state decryption equation applicable to the plurality of different cryptographic algorithms to implement the selected cryptographic algorithm. Examples of such equations are provided in Tables 2 and 4 above. A cryptographic algorithm may be selected by, e.g., programming the controller 50 or providing a selection indication to the controller 50. In a software implementation, an indication of a selected cryptographic algorithm may be received, e.g., by receiving an indication of a cryptographic algorithm (e.g., “CBC”) or by receiving indications of values of variables (e.g., for the expressions shown in Table 4) that correspond to a particular cryptographic algorithm.

The method 210 may further include other features and/or stages. For example, the method 210 may further include determining an authentication tag, associated with the output data, using an authentication circuit to perform a one-way function, e.g., as discussed with respect to FIGS. 9-13. The method 210 may further include providing a constant logical zero signal to the authentication circuit while the authentication circuit is idle. The authentication tag may be determined using at least one logical signal combiner, in the network of switches and logical signal combiners, through which data pass in implementing the selected cryptographic algorithm. The cryptographic algorithm implemented is a first cryptographic algorithm and the method 210 may further include implementing another, second cryptographic algorithm that is different from the first cryptographic algorithm. The second cryptographic algorithm may be implemented by receiving other input data, directing the other input data through the cipher circuit and through the network of switches and logical signal combiners differently than when implementing the first cryptographic algorithm.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A cryptographic device comprising:
a data input;
a data output;
a cipher circuit configured to perform a cipher algorithm on cipher-algorithm input data to produce cipher-algorithm output data; and
a network coupled to the data input, the data output, and the cipher circuit, the network comprising a plurality of switches and a plurality of logical signal combiners that are configured to provide the cipher-algorithm input data to the cipher circuit and to provide device output data to the data output using the cipher-algorithm output data and that, in combination with the cipher circuit, are configured to implement a plurality of different cryptographic algorithms that each include the cipher algorithm that the cipher circuit is configured to perform.

2. The device of claim 1, wherein the cipher circuit is a single instance of the cipher circuit.

3. The device of claim 1, wherein the network includes a controller configured to be programmed to actuate the plurality of switches differently to implement the plurality of different cryptographic algorithms.

4. The device of claim 3, wherein the controller is configured to be programmed to actuate the plurality of switches differently to cause different logical combinations of signals to provide different cipher-algorithm input data from the data input to the cipher circuit and/or to cause different logical combinations of the cipher-algorithm output data to provide the device output data to the data output to implement the plurality of different cryptographic algorithms.

5. The device of claim 3, wherein the controller is configured to be programmed to actuate the plurality of switches differently to effect values of respective variables in equations representing the plurality of different cryptographic algorithms to implement the plurality of different cryptographic algorithms.

6. The device of claim 5, wherein the controller is configured to be programmed to actuate the plurality of switches differently to effect values of respective variables in an initial-state encryption equation, a steady-state encryption equation, an initial-state decryption equation, and a steady-state decryption equation to implement the plurality of different cryptographic algorithms.

7. The device of claim 3, wherein the controller implements a state machine.

8. The device of claim 3, wherein the controller comprises a memory and a processor communicatively coupled to the memory, the memory comprising processor-readable instructions configured to cause the processor to actuate the plurality of switches selectively.

9. The device of claim 1, further comprising an authentication circuit coupled to the network and configured to determine an authentication tag, the network being configured to provide a constant logical zero signal to the authentication circuit during a time when the cryptographic device is active but the authentication circuit is not determining the authentication tag.

10. The device of claim 1, further comprising an authentication circuit coupled to the network and configured to determine an authentication tag in combination with the network, the authentication circuit being separate from the cipher circuit, wherein the network is configured such that at least a same one of the plurality of switches and/or at least a same one of the plurality of logical signal combiners is used to perform at least one of the plurality of different cryptographic algorithms and to determine the authentication tag.

11. The device of claim 1, wherein the network and the cipher circuit are configured to implement the plurality of different cryptographic algorithms without an unregulated loop.

12. A cryptographic device comprising:
a data input configured to receive cryptographic algorithm input data;
a data output; and
means, coupled to the data input and the data output, for implementing a plurality of different cryptographic algorithms, the means for implementing comprising:
cipher means for performing a cipher algorithm on cipher-algorithm input data to produce cipher-algorithm output data; and
network means, coupled to the cipher means, for producing, based upon the cryptographic algorithm being implemented, cipher-algorithm input data from the cryptographic algorithm input data, for providing the cipher-algorithm input data to the cipher means, for producing, based upon the cryptographic algorithm being implemented, cryptographic algorithm output data from the cipher-algorithm output data, and for providing the cryptographic algorithm output data to the data output.

13. The device of claim 12, wherein the network means are for selectively logically combining data based upon the cryptographic algorithm being implemented.

14. The device of claim 13, wherein the network means are configured to actuate a plurality of switches differently to implement the plurality of different cryptographic algorithms.

15. The device of claim 13, wherein the network means are configured to provide different combinations of data inputs to one or more logical signal combiners to implement the plurality of different cryptographic algorithms.

16. The device of claim 15, wherein the network means are configured to provide the different combinations of data inputs to effect values of respective variables in an initial-state encryption equation, a steady-state encryption equation, an initial-state decryption equation, and a steady-state decryption equation to implement the plurality of different cryptographic algorithms.

17. The device of claim 12, wherein the means for implementing further comprise authentication means, coupled to the network means, for determining an authentication tag associated with the cryptographic algorithm output data, the network means being further for providing a constant logical zero signal to the authentication means during a time when the cryptographic device is active but the authentication means are not determining the authentication tag.

18. The device of claim 12, wherein the means for implementing further comprise authentication means, coupled to the network means, for determining an authentication tag associated with the cryptographic algorithm output data, the network means and the authentication means sharing at least one switch and/or at least one logical signal combiner.

19. A cryptographic method comprising:
receiving cryptographic algorithm input data at a cryptographic device;
directing the cryptographic algorithm input data in the cryptographic device through a network of switches and logical signal combiners to produce cipher-algorithm input data;
performing a cipher algorithm on the cipher-algorithm input data in a cipher circuit to produce cipher-algorithm output data; and
directing the cipher-algorithm output data in the cryptographic device through the network of switches and logical signal combiners to produce cryptographic algorithm output data;
wherein the cryptographic algorithm input data and the cipher-algorithm output data are directed through the network of switches and logical signal combiners based upon a selected cryptographic algorithm from a plurality of cryptographic algorithms implementable by different paths through the network of switches and logical signal combiners, with each path including the cipher circuit.

20. The method of claim 19, wherein directing the cryptographic algorithm input data, performing the cipher algorithm, and directing the cipher-algorithm output data implement values of respective variables in an initial-state encryption equation, a steady-state encryption equation, an initial-state decryption equation, and a steady-state decryption equation applicable to the plurality of different cryptographic algorithms to implement the selected cryptographic algorithm.

21. The method of claim 19, further comprising determining an authentication tag, associated with the cryptographic algorithm output data, using an authentication circuit to perform a one-way function.

22. The method of claim 21, further comprising providing a constant logical zero signal to the authentication circuit while the authentication circuit is idle.

23. The method of claim 21, wherein the authentication tag is determined using at least one logical signal combiner, in the network of switches and logical signal combiners, through which data pass in implementing the selected cryptographic algorithm.

24. The method of claim 19, wherein the cryptographic algorithm input data are first cryptographic algorithm input data, the cipher-algorithm input data are first cipher-algorithm input data, and the cryptographic algorithm output data are first cryptographic algorithm output data corresponding to a first cryptographic algorithm of the plurality of cryptographic algorithms, the method further comprising:
receiving second cryptographic algorithm input data at the cryptographic device;
directing the second cryptographic algorithm input data in the cryptographic device through the network of switches and logical signal combiners to produce second cipher-algorithm input data;
performing the cipher algorithm on the second cipher-algorithm input data in the cipher circuit to produce second cipher-algorithm output data; and
directing the second cipher-algorithm output data in the cryptographic device through the network of switches and logical signal combiners to produce second cryptographic algorithm output data corresponding to a second cryptographic algorithm of the plurality of cryptographic algorithms, the second cryptographic algorithm being different from the first cryptographic algorithm.

25. A non-transitory, processor-readable storage medium comprising processor-readable instructions configured to cause a processor to:
receive cryptographic algorithm input data;
receive an indication of a selected cryptographic algorithm from a plurality of different cryptographic algorithms;
produce, based upon the selected cryptographic algorithm, cipher-algorithm input data from the cryptographic algorithm input data;
perform a cipher algorithm on the cipher-algorithm input data to produce cipher-algorithm output data; and
produce, based upon the cryptographic algorithm being implemented, cryptographic algorithm output data from cipher-algorithm output data.

26. The storage medium of claim 25, wherein the instructions configured to produce the cipher-algorithm input data and/or the instructions configured to cause the processor to produce the cryptographic algorithm output data are configured to cause the processor to selectively logically combine data based upon the selected cryptographic algorithm.

27. The storage medium of claim 26, wherein the instructions configured to cause the processor to selectively logically combine data are configured to cause the processor to provide a particular combinations of data, based upon the selected cryptographic algorithm, to be logically combined.

28. The storage medium of claim 28, wherein the instructions configured to cause the processor to provide the particular combination of data are configured to cause the processor to provide the particular combination of data to effect values of respective variables in an initial-state encryption equation, a steady-state encryption equation, an initial-state decryption equation, and a steady-state decryption equation to implement the selected cryptographic algorithm.

29. The storage medium of claim 25, further comprising instructions configured to cause the processor to determine an authentication tag associated with the cryptographic algorithm output data.
